(19) United States
(12) Patent Application Publication
(10) Pub. No.: US 2002/0170762 A1
(43) Pub. Date: Nov. 21, 2002

(54) Automobile speed limiter system

(76) Inventor: Mohammad R. Daneshmand, Los Angeles, CA (US)

Correspondence Address: ALLAN M. SHAPIRO, Suite 202, 18401 Burbank Boulevard, Tarzana, CA, 91356-2824, US

(21) Appl. No.: 09/861,440

(22) Filed: May 21, 2001

(51) Int. Cl. B60K 31/02

(52) U.S. Cl. 180/178; 180/179

(57) ABSTRACT

The speed of an automobile is limited by a throttle controller between the gas pedal and the throttle valve. The controller is actuated by a digital or analog processor in a speed limiter control module. The speed limiter control module receives vehicle speed and has a maximum speed input device such as a keypad and a readout display panel which indicates the maximum speed set. When the vehicle speed exceeds the set speed, the throttle controller disengages the gas pedal from the throttle valve to prevent the gas pedal from causing further speed increase. The speed limiter control module is lockable so that only authorized persons are allowed to reset the maximum speed. This allows the owner to preset a maximum speed and loan the automobile to his offspring or others knowing that they will be speed limited. In the same manner, maximum acceleration and/or engine RPM can be preset and controlled.

### FIELD OF THE INVENTION

This automobile speed limiter system is configured to be placed on one's own vehicle and is lockable and settable so that, when the vehicle is loaned to a permitted user, the speed is limited.

### BACKGROUND OF THE INVENTION

Automobiles are generally used for personal transportation by large numbers of the public. Oftentimes, an automobile is owned by the family, and there are several users. The owner is often the parent, who permits others to use the automobile on specific occasions. When the occasional user is the offspring of the parent, the parent often wonders if the automobile is being driven safely. This more usually occurs when the permitted user is a son, often when the child is a first-time driver as when the child arrives at the age of 16 years and becomes legally able to train for and obtain a driver's license.

It is desirable in this and other family situations for the parent to be able to limit the maximum speed at which the automobile can be driven and to lock that maximum speed limit in place while the offspring is operating the automobile with the parent's permission. This would allow the parent to have more confidence in the offspring driving the car without excessive speed.

In some cases, it may also be expedient to limit acceleration of the automobile when it is operating below the limited maximum speed, especially since modern cars are significantly overpowered. Thus, it is desirable to provide an automobile speed and/or acceleration limiter system which permits the owner of the automobile to set a maximum operating speed and/or acceleration into the system and to lock it therein to prevent other users of the automobile from exceeding the owner-determined maximum speed and/or acceleration. This situation also may arise with rental cars and company-owned cars available to employees.

### SUMMARY OF THE INVENTION

In order to aid in the understanding of this invention, it can be stated in essentially summary form that it is directed to an automobile speed limiter system which includes a control module and an electro-mechanical throttle actuator which disengages the usual foot operated gas pedal from the throttle valve when automobile speed or acceleration exceeds the maximum speed and/or acceleration set and locked into the control module by the automobile owner.

It is thus a purpose and advantage of this invention to provide an automobile speed limiter system which includes a control module and an electro-mechanical throttle actuator. The throttle actuator is between the gas pedal and the throttle valve. The limiter system includes a control module into which maximum speed and/or acceleration can be set and locked. The control module senses the speed and/or acceleration of the automobile and signals the throttle actuator to effectively disengage the gas pedal from the throttle valve when the preset maximum speed and/or acceleration is exceeded.

It is another purpose and advantage of this invention to provide an automobile speed limiter system which permits the owner of the automobile to set and limit the maximum permissible speed and/or acceleration of the automobile by other users.

It is another purpose and advantage of this invention to provide an automobile speed limiter system so that the owner of an automobile can loan out the automobile and limit the maximum speed and/or acceleration of the automobile during use by the borrower.

It is another purpose and advantage of this invention to provide an automobile speed limiter system which can be incorporated as part of the automobile during the manufacture thereof.

It is another purpose and advantage of this invention to provide an automobile speed limiter system which can be installed on the automobile after it has been manufactured.

The features of the present invention which are believed to be novel are set forth with particularity in the appended claims. The present invention, both as to its organization and manner of operation, together with further objects and advantages thereof, may be best understood by reference to the following description, taken in conjunction with the accompanying drawings.

### BRIEF DESCRIPTION OF THE DRAWINGS

FIG. 1 is a diagrammatic drawing of the first preferred embodiment of the automobile speed limiter system of this invention, suitable for after-market installation.

FIG. 2 is a diagrammatic drawing of the second preferred embodiment of the automobile speed limiter system of this invention, suitable for original equipment installation in the automobile.

FIG. 3 is a diagrammatic drawing of the third preferred embodiment of the automobile speed limiter system of this invention, suitable for after-market installation.

FIG. 4 is a diagrammatic drawing of the fourth preferred embodiment of the automobile speed limiter system of this invention, suitable for original equipment installation in the automobile.

FIG. 5 is a diagrammatic drawing of the fifth preferred embodiment of the automobile speed limiter system of this invention, suitable for original equipment installation in the automobile.

### DESCRIPTION OF THE PREFERRED EMBODIMENTS

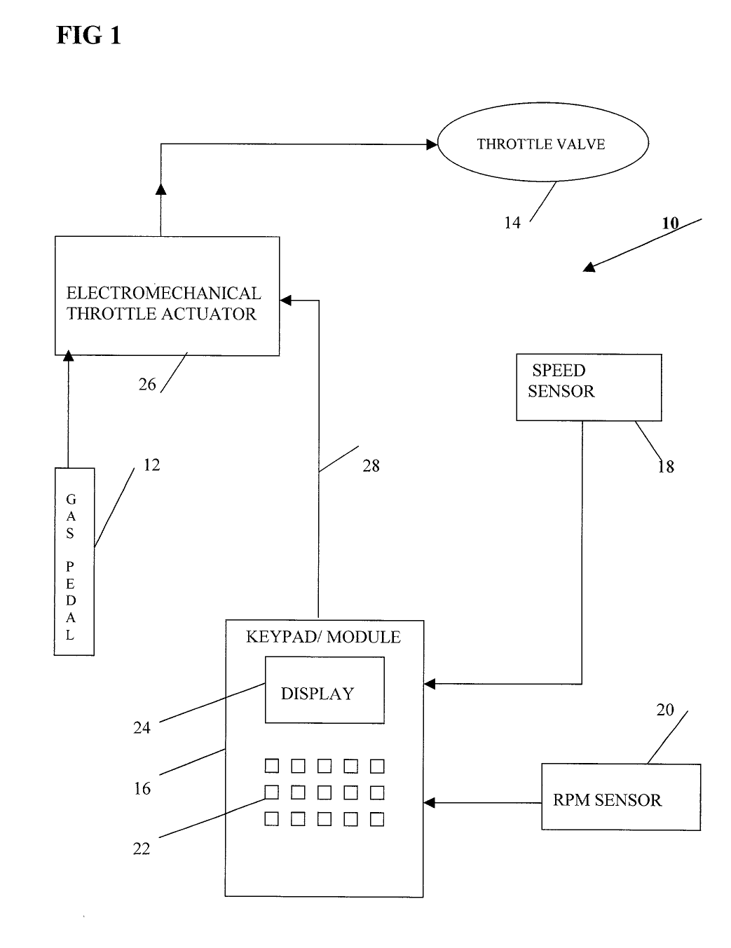

The first preferred embodiment of the automobile speed limiter system is generally indicated at 10 in FIG. 1. The automobile, as purchased, has a foot operated accelerator pedal or gas pedal 12, which is connected to throttle valve 14 by cable or linkage. The throttle valve 14 throttles the amount of air to the engine. In the conventional fuel-injected engine of present-day automobiles, the throttle valve is connected to a throttle valve position transducer which is connected to the engine computer, which controls the fuel injectors. This causes a suitable air/fuel ratio in the conventional automobile.

In accordance with this invention, automobile speed limiter module 16 is supplied. Inputs to the module 16 include the output of the automobile speed sensor 18 and, optionally, the output of an engine RPM sensor 20. The module 16 includes a digital or analog processor. An additional input to the digital processor is keypad 22, which is preferably a 10-key numerical pad plus other function keys. The additional function keys would include an ENTER key, a CORRECT key (which would cancel the previously entered keyed-in data which is not yet entered), a DISPLAY key to cause presently entered data to be displayed on display panel 24, a MENU key and a LOCK key.

In function, the owner of the automobile unlocks the keyboard by entering an unlocking code including a password. As an alternative, a mechanical switch operated by a key could be employed. When the keyboard is unlocked, a maximum speed is keyed into the key pad 22. When it is correct, the ENTER key is actuated. The DISPLAY key is actuated to display these values, and the keyboard is locked.

The automobile is started and is driven away by the usual manipulation of the gas pedal, steering and brakes. The mechanical signal from the gas pedal to the throttle valve passes directly through the actuator 26. When the speed of the automobile passes the preset maximum speed limit, a signal is emitted from the module through line 28 to the throttle actuator 26. This signal disengages the gas pedal 12 from the throttle valve 14 so that the throttle valve cannot exceed its pre-set maximum speed setting.

The control module provides a prewarning which advises a driver he has almost reached the limit. This can be by sound and/or light. Another warning can be employed to indicate when disengagement occurs.

Under most circumstances, the automobile will now slow down. The electro-mechanical throttle actuator 26 is such that, when the gas pedal 12 is released by raising the foot and the line 28 no longer has a signal in it, because the speed of the automobile is below the predetermined speed set in the digital processor in the speed limiter module 16, then the gas pedal is re-engaged to actuate the throttle valve.

If it is desirable that the acceleration also be limited, then the acceleration data is set into the processor. The change in speed data from speed sensor 18 is considered versus time, and when the acceleration exceeds the preset limit, the same disengagement of the gas pedal occurs by a signal in line 28. Furthermore, the engine RPM can be sensed by sensor 20, and an engine RPM limit can be set into the digital processor. When the engine RPM exceeds the preset value, the signal is again transmitted in line 28 to prevent exceeding the pre-set maximum RPM.

The digital processor is locked to outside adjustment except by the person who has the key. The key may be mechanical or it may be a keypad entry code or password. When unlocked, the keypad can be actuated for a new maximum speed limit, acceleration limit, and/or engine RPM limit. These limits are entered and locked into the module 16 and its digital processor. In this way, the owner of the automobile can limit it from unsafe speeds and excess mechanical stress.

One manner in which the speed limiting module can be programmed is that one password permits setting of the maximum speed for each permitted driver. Each driver is assigned his own password. For driver One, a first maximum speed can be set, and for driver Two, a different maximum speed can be set. When a driver enters the vehicle and starts the engine, he enters his own password. The speed-limiting module limits the speed permitted for that user. This personal password is not the unlocking code so that it does not permit that driver to reset the speed-limiting module.

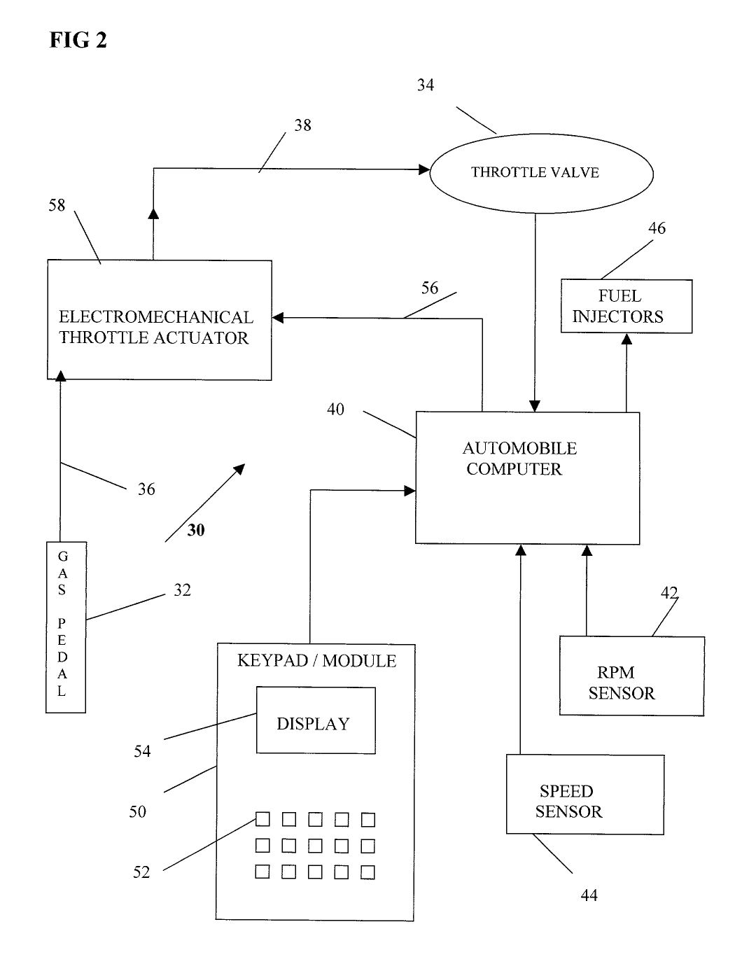

FIG. 2 illustrates the manner in which the automobile speed limiter system is incorporated into an engine management system during original vehicle manufacture. Without the automobile speed limiter system 30 of FIG. 2, a gas pedal 32 actuates throttle valve 34 through mechanical linkage or cables 36 and/or 38. The throttle valve has a position output signal to the automobile computer, referred to as the engine management digital computer 40. This gives a signal as to the driver's desire to increase or decrease speed. The engine management computer 40 also receives engine RPM signals from engine RPM sensor 42 and vehicle speed signals from speed sensor 44. These and other signals cause an output from the automobile computer 40 to control the fuel injectors 46 of the usual modern vehicle system or directly to the throttle valve 34.

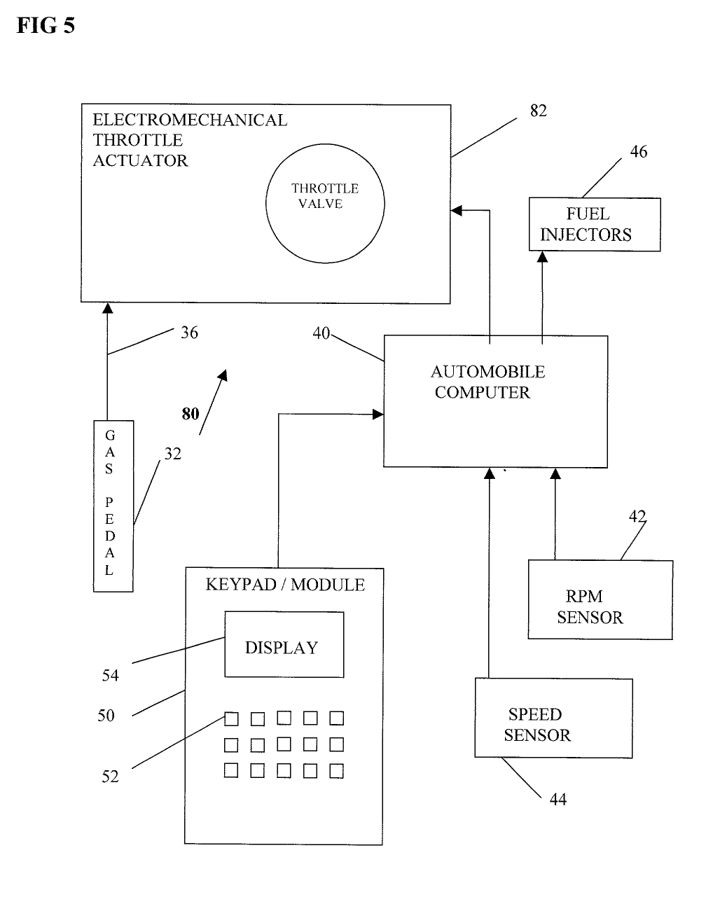

In accordance with this invention, the embodiment of FIG. 2 includes an automobile speed limiter module 50, which carries a keypad 52 and a display panel 54. The keypad 52 has the same external appearance as the one at 22 described above, wherein there are ten numerical keys as well as other function keys such as ENTER, CORRECT, DISPLAY, MENU and/or LOCK. Before he permits another person to use the vehicle, the owner unlocks the programming of the processor in module 50. He then sets the processor to the desired maximum speed and such other operating criteria that he deems helpful, as described above with respect to the system 10. When the new criteria are entered into the processor in the module 50, they are locked in. Locking may be by a locking key on the keypad or by a physical locking key. When the keypad entry causes locking, resetting cannot be accomplished until the processor is unlocked by entering an unlocking code. The processor 50 is in communication with the processor in the engine management computer 40. The engine management computer 40 compares the speed of the vehicle from sensor 44 with the maximum value issued by the module 50. When the automobile speed exceeds the defined maximum speed, the engine management computer 40 issues a command through line 56 to the electro-mechanical throttle actuator 58. The throttle actuator 58 is a connection between the linkages 36 and 38, but when a signal on line 56 causes actuation of actuator 58, disengagement between the mechanical linkages 36 and 38 occurs and the speed remains at the pre-set maximum. The disconnection or disengagement remains until the driver takes his foot off of the gas pedal 32 and the sensed speed of the automobile goes below the maximum speed limited value defined by the module 50. Thereupon, the throttle is returned to the control of the driver. It should be understood that the throttle actuator 58 and the throttle valve 34 may be manufactured as a unit, as described hereafter in relation to FIG. 5.

In a similar manner to that described above in relation to FIG. 1, the speed limiter module 50 can be programmed so that one password permits setting of the maximum speed for each permitted driver. A password is assigned for each driver. For driver One, a first maximum speed can be set, and for driver Two, a different maximum speed can be set. When a driver enters the vehicle and starts the engine, he enters his own password. The speed limiter module 50 limits the speed permitted for that user. This personal password is not the unlocking code so that it does not permit that driver to reset the speed limiter module.

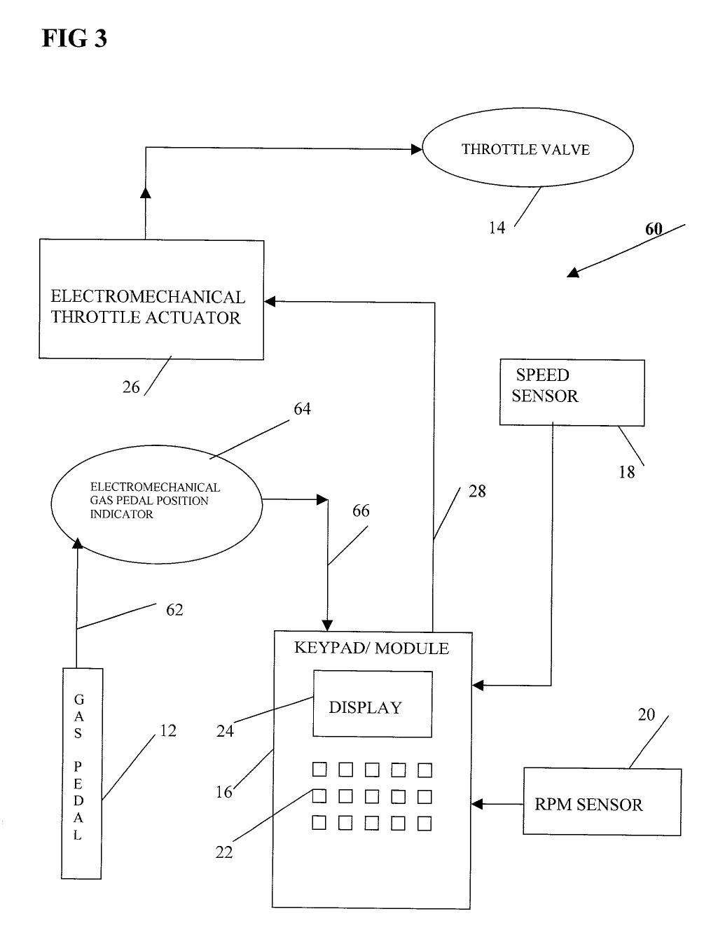

Referring to FIG. 3, the automobile speed limiter system generally indicated at 60 embodies a modification of the system 10 in FIG. 1 and, for convenience and clarity, the same elements bear the same reference numerals as in FIG. 1. The gas pedal 12 is connected through a cable or linkage 62 to an electromechanical gas pedal position indicator 64. The pedal position indicator 64 supplies an electrical signal along line 66 to the module 16 for processing by the module 16 and control of the electromechanical throttle actuator 26 and further operation as described above in connection with FIG. 1.

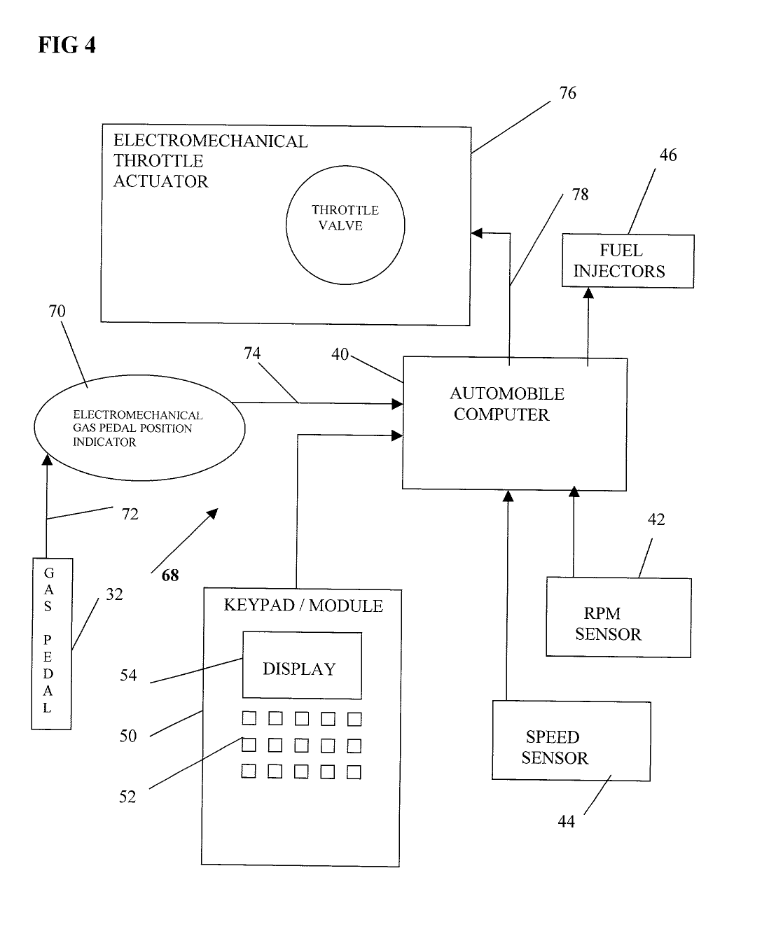

Referring to FIG. 4, the automobile speed limiter system generally indicated at 68 is similar to the system 30 described in connection with FIG. 2, and the same or similar elements bear the same reference numerals as in FIG. 2. Here, the gas pedal 32 is connected to an electromechanical gas pedal position indicator 70 through a cable or linkage 72, and the gas pedal position signal data is supplied via line 74 to the automobile computer 40. Since this illustrated embodiment pertains to an original equipment installation, the electromechanical throttle actuator and the throttle valve are supplied as a single sub-assembly unit 76 for receiving the control signals from the automobile computer 40 on line 78. Otherwise, system 68 operates in the same manner as described above in connection with FIG. 2.

Referring to FIG. 5, as mentioned previously in connection with the description of FIG. 2, the system 80 is the same as the system 30 with the exception that the electromechanical throttle actuator and the throttle valve are supplied as a single sub-assembly unit 82. Accordingly, the same reference numerals are applied to the same elements, and the operation is the same as described above in connection with FIG. 2.

This system, as described above in connection with all of the FIGURES, permits the owner of the automobile (often the father in the family) to set the maximum permissible speed and/or acceleration and/or engine RPM in a manner such that it cannot be easily changed by a young driver in the family. When the maximum limits are set, they remain set until the module is unlocked and the maximums are reset. This permits the owner of the automobile to limit speed, acceleration and/or engine RPM, minimize danger to his offspring and other users of the automobile as well as the public, and reduce wear to his automobile.

This invention has been described in its presently contemplated best modes, and it is clear that it is susceptible to numerous modifications, modes and embodiments within the ability of those skilled in the art and without the exercise of the inventive faculty. Accordingly, the scope of this invention is defined by the scope of the following claims.

What is claimed is:

1. An automobile speed limiter system comprising:
a speed limiter module, said speed limiter module having digital electronics therein, said speed limiter module having a keypad connected to said digital electronics for permitting the owner of an automobile to enter a maximum speed therein;
a locking system in said speed limiter module for locking the maximum speed therein so that the maximum speed cannot be changed without the key to the locking mechanism, said locking system having a key held by the owner of the automobile;
an automobile speed sensor connected to said speed limiter module; and
an electro-mechanical throttle actuator connected to said module, said electro-mechanical throttle actuator being for connection between the gas pedal and the engine throttle valve of the automobile so that, when said speed sensor detects a speed greater than the maximum speed set into said speed limiter module, said electro-mechanical throttle actuator is actuated to disengage the gas pedal from the engine throttle valve so the engine cannot drive the automobile any faster.

2. The automobile speed limiter system of claim 1 wherein said electro-mechanical throttle actuator is signaled to reconnect the gas pedal to the throttle valve when the sensed velocity of the automobile is decreased below the maximum speed limit set into said module.

3. The automobile speed limiter system of claim 1 wherein said speed limiter module also has a maximum engine RPM value set therein, there is an engine RPM sensor for sensing the RPM of the automobile engine, said RPM sensor being connected to said speed limiter module to cause said speed limiter module to actuate said electro-mechanical throttle actuator to disconnect the accelerator pedal from the engine management system when the maximum engine RPM is detected.

4. The automobile speed limiter system of claim 1 wherein said speed limiter module also has a maximum acceleration value set therein and there is an engine RPM sensor for sensing the RPM and acceleration of the automobile engine, said RPM sensor being connected to said speed limiter module to cause said speed limiter module to actuate said electro-mechanical throttle actuator to disconnect the accelerator pedal from the engine management system when the maximum permissible acceleration is detected.

5. The automobile speed limiter system of claim 3 wherein said electro-mechanical throttle actuator is signaled to reconnect the gas pedal to the engine management system when the sensed speed of the automobile is decreased below the maximum speed limit set into said module.

6. The automobile speed limiter system of claim 2 wherein said lock in said speed limiter module is an electronic lock which is unlocked by manipulating a correct code into said speed limiter module by means of said keypad.

7. The automobile speed limiter system of claim 2 wherein said system is incorporated into an automobile during manufacture of said automobile and said automobile includes an engine management computer, said speed limiting module being connected to said automobile engine management computer and said automobile engine management computer being connected to said electro-mechanical throttle actuator.

8. The method of limiting the speed of an automobile by the owner of the automobile so that the automobile can be used only below a preset speed by a driver other than the owner with the permission of the owner comprising the steps of:
entering into a speed limiter electronic processor module in the automobile a predetermined maximum set speed so that a user other than the owner can operate the automobile only below the predetermined maximum set speed;
engaging an electro-mechanical throttle actuator between the gas pedal and engine throttle valve of the automobile so that when signaled the electro-mechanical throttle actuator disengages the gas pedal from the engine throttle valve;
sensing the speed of the automobile so that, when the speed equals the preset maximum speed entered into the electronic processor module, the electronic processor module emits a signal which actuates said electro-mechanical throttle actuator to disengage the gas pedal from the throttle valve so as to maintain the preset maximum speed.

9. The method of claim 8 further including the step of unlocking the electronic speed limiter module by entering an unlocking code into the keypad;
resetting the maximum speed permitted; and
relocking the electronic speed limiter module by making a keypad entry.

10. The method of limiting the speed of an automobile comprising the steps of:
installing an electronic speed limiter module on the automobile;
connecting an electro-mechanical throttle actuator between the accelerator pedal and the engine management system of the automobile;
connecting an automobile speed sensor to the automobile to emit a signal corresponding to the automobile speed and comparing the signal to the maximum speed limit entered into the electronic speed limiter module;
entering a maximum automobile speed into the electronic speed limiter module;
locking the entered speed into the electronic speed limiter module;
permitting another person to use the automobile; and
limiting the automobile speed by comparing the speed with the entered maximum automobile speed limit and actuating the electro-mechanical throttle actuator when the automobile speed exceeds the entered speed and emitting the signal to the electro-mechanical throttle actuator to disengage the throttle from the engine management system so as to limit the speed of the automobile.

11. The method of claim 10 wherein the electro-mechanical throttle actuator is reset to re-engage the accelerator pedal to the engine management system by reducing the speed below the set speed and releasing the accelerator pedal.

12. The method of claim 10 wherein the speed limit set into the electronic module is reset by unlocking the module by entering an unlocking code, thereupon entering a new automobile speed limit and relocking the module.

13. The method of claim 11 wherein the electro-mechanical throttle actuator is reset to re-engage the accelerator pedal to the engine management system by reducing the speed below the set speed and releasing the accelerator pedal.
